(19) United States
(12) Patent Application Publication
(10) Pub. No.: US 2004/0088424 A1
(43) Pub. Date: May 6, 2004

(54) SIP-based load balancing apparatus and method

(76) Inventors: Mi Ryong Park, Daejeon (KR); Joo Myoung Seok, Daejeon (KR); Hyun Joo Kang, Kyungsangbook-do (KR); Gil Young Choi, Daejeon (KR); Kyou Ho Lee, Daejeon (KR); Yoo Kyoung Lee, Daejeon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/464,675

(22) Filed: Jun. 18, 2003

(30) Foreign Application Priority Data
Oct. 30, 2002 (KR) 2002-66448

(51) Int. Cl. G06F 15/16

(52) U.S. Cl. 709/229

(57) ABSTRACT

The present invention provides a Session Initiation Protocol (SIP)-based load balancing apparatus and method. The apparatus receives a message transmitted from a user at a position in front of a plurality of proxy servers each connected in parallel and decodes the received message. The apparatus selectively performs addition, renewal and deletion of user information according to an expiration field of a header and transmits the decoded message to a proxy server, if the decoded message is a REGISTER message, searches for a proxy server that will handle a destination address, increases a load of the proxy server and transmits the decoded message to the proxy server, if the decoded message is a INVITE message, and examines a proxy server of the destination address and transmits the decoded message to the proxy server, if the decoded message is a BYE message.

### BACKGROUND OF THE INVENTION

1. Field of the Invention

The present invention relates generally to a session initiation protocol (SIP)-based load balancing apparatus and method, and more particularly to a SIP-based load balancing apparatus and method, in which a plurality of proxy servers which process session initiation protocol calls, respectively, are arranged in parallel with each other, and processing loads are balanced at a position in front of the proxy servers arranged in parallel with each other.

2. Description of the Prior Art

In order to provide packet-based voice services on the Internet, a variety of protocols are employed. In particular, International Telecommunication Union-Telecom section (ITU-T), which pursues the standardization of communication equipment and systems, has standardized Internet voice communication services of H.323 series, while the Internet Engineering Task Force (IETF), which pursues the standardization of Internet operating protocols, has standardized a Session Initiation Protocol (SIP) for Internet-based voice services.

An SIP is a technology that employs terminal user identifiers based on Uniform Resource Locators (URLs) and provides address registration, address translation, call routing and added services through the application program-based interpretation of the identifiers. It is expected that the SIP will be widely exploited because it is easy to develop and expand due to its similarity to text-based Web services. Proxy servers and registration servers, called registrars, are required to provide SIP-based voice services on the Internet. Currently, proxy servers are designed to provide user roaming services and call routing services for their internal users, and call routing services for external domains. The proxy servers provide registration and call routing functions through communication with the registration servers (registrars).

Up to the present, user registration and application program-based call routing is performed using proxy servers and registrars. Additionally, the use of Domain Name System (DNS) Service location (SRV) support is defined by the IETF as a standard for searching for a proxy server in an outside domain. Such DNS SRV support allows representative processing servers of domains of various services to be recorded. When the DNS SRV support is employed in the SIP, the same environment can be provided to a plurality of users and all calls can be processed by proxy servers registered with the DNS SRV support. However, for proxy servers statically arranged by a manager, excessive loads may be imposed on a single proxy server, or the proxy servers cope with dynamic environment, thus delaying call processing.

In order to solve the above-described problem, proxy servers for processing calls are arranged in parallel with each other so that loads are balanced by distributing the loads among the parallelly arranged proxy servers. However, in this conventional method, in the case where a proxy server used at the time of user registration is different from a proxy server used at the time of call processing, a problem arises in routing at the time of call processing. Meanwhile, in the case where a single registration server is employed to parallelly process loads, the registration server cannot be used in the same network along with another proxy server. Additionally, in the case of a stateful proxy that records the state management of a message at the time of call processing, the state management of messages is not performed. In particular, the conventional method is problematic in that loads are not balanced in the case where the processing of the loads is concentrated into a single proxy server due to the mistaken setting of probability by a manager.

### SUMMARY OF THE INVENTION

The present invention provides a SIP-based load balancing apparatus and method, which can dynamically balance loads at a position in front of a plurality of proxy servers for processing SIP calls in consideration of loads of user registration and call processing for call routing services.

In additions, the present invention provides a SIP-based load balancing apparatus, the SIP-based load balancing apparatus being connected in parallel to a plurality of proxy servers for providing SIP-based voice services, which includes a control unit for controlling entire management and operation of the apparatus; a server table for managing lists of the proxy servers on the basis of destination addresses of users; a management element table for managing lists of the users on the basis of destination addresses of REGISTER messages; an input unit for receiving a message transmitted from one of the users; a processing unit for decoding the message received by the input unit, and balancing loads of the each proxy server in such a way as to distribute a REGISTER message to a corresponding proxy server depending on the loads of the proxy servers if the decoded message is the REGISTER message and increase or decrease a load of a corresponding proxy server if the decoded message is an INVITE message or a BYE message; an output unit for outputting processed results to corresponding proxy servers; and a timer task unit for examining the server table and the management element table at preset periods and deleting expired lists.

In this case, the SIP-based load balancing apparatus is connected in parallel to the plurality of proxy servers at a position in front of the proxy servers. If the decoded message is a REGISTER message, the processing unit ascertains current loads of the each proxy server, selects a proxy server having a smallest load among the proxy servers, transmits the REGISTER message to the proxy server having the smallest load, and stores a registration result in the management element table.

The server table includes a first field for recording a proxy server to be managed, a second field for recording a load of the proxy server to be managed, a probability value field for designating a server on the basis of probability, a third field for recording characteristics of the apparatus designated by a manager, and an option field for handling an option. The management element table includes a uniform resource locator field designed to identify a user, a fourth field for recording an actual proxy server that will handle the user, a fifth field for recording time when REGISTER message of the user is received, a sixth field for recording an expiration value included in the RESISTER message, and an option field provided to prepare for future expansion.

In the meantime, the input unit opens a set port, stands by for a message input from a user and examines the input message for an error.

In addition, the present invention provides a SIP-based load balancing method, which includes a first step of receiving a message transmitted from a user at a position in front of a plurality of proxy servers each being connected in parallel, examining the message for an error, and decoding the received message if the received message is not erroneous; a second step of selectively performing addition, renewal and deletion of user information according to an expiration field of a header, and transmitting the decoded message to a proxy server, if the decoded message is a REGISTER message; a third step of searching for a proxy server that will handle a destination address, increasing a load of the proxy server and transmitting the decoded message to the proxy server, if the decoded message is a INVITE message; a fourth step of ascertaining a corresponding proxy server by examining the destination address, if the decoded message is a BYE message; and a fifth step of decreasing a load of the proxy server and transmitting the decoded message to the proxy server after the fourth step is performed.

The third step includes a sixth step of determining whether a value of an expiration field of a header of the REGISTER message is zero; a seventh step of deleting user information from a previously stored list and transmitting the REGISTER message to an actual processing proxy server, if the value of the expiration field is zero as a result of the determination at the sixth step; an eight step of determining whether user information exists in the previously stored list, if the value of the expiration field is not zero as a result of the sixth step; a ninth step of renewing the user information of the previously stored list and transmitting the REGISTER message to a proxy server existing in the previously stored list, if the user information exists in the previously stored list as a result of the determination at the eighth step; and a tenth step of searching for a proxy server that will handle the REGISTER message and transmitting the REGISTER message to the proxy server, if the user information does not exist in the previously stored list as a result of the determination at the eighth step. In this case, the tenth step is performed in such a way that the proxy server is searched for by a weighted round robin technique.

In addition, the present invention provides a computer-readable storage medium, which includes a program capable of implementing a first function of receiving a message transmitted from a user at a position in front of a plurality of proxy servers each being connected in parallel, examining the message for an error, and decoding the received message if the received message is not erroneous; a second function of selectively performing addition, renewal and deletion of user information according to an expiration field of a header, and transmitting the decoded message to a proxy server, if the decoded message is a REGISTER message; a third function of searching for a proxy server that will handle a destination address, increasing a load of the proxy server and transmitting the decoded message to the proxy server, if the decoded message is a INVITE message; a fourth function of ascertaining a corresponding proxy server by examining the destination address, if the decoded message is a BYE message; and a fifth function of decreasing a load of the proxy server and transmitting the decoded message to the proxy server after the fourth function is performed.

The present invention provides the SIP-based load balancing apparatus and method, which distributes loads at a position in front of a plurality of proxy servers that are arranged in parallel with each other because the use of the plurality of proxy servers is effective in balancing loads. The load balancing apparatus of the present invention is constructed to be used in conjunction with DNS SVR support, and connected in parallel to the plurality of proxy servers. Additionally, the load balancing apparatus of the present invention calculates the loads of proxy servers on the basis of the identifier addresses of user terminals, and dynamically distributes loads among the proxy servers in such a way as to allow a proxy server having a smallest number of loads to handle a new user in the case where the new user registers.

Terminals inside a domain recognize a representative load balancing apparatus as a proxy server, and request registration and call processing from the representative load balancing apparatus. First, a terminal inside a domain requests registration from a proxy server to use a call routing service. At this time, the load balancing apparatus of the present invention receives a registration request message, that is, a REGISTER message, from a user, and transmits the received REGISTER message to a proxy server selected among proxy servers on the basis of the current state of loads of the proxy servers to process the received REGISTER message. In this case, a proxy server having a smallest number of loads is selected among the proxy servers on the basis of the current state of loads, and the selection of the proxy server is recorded in a management element table. For the renewal or deletion of a previously registered user, a previous processing proxy server is searched for, a received message is transmitted to the previous processing proxy server, and the registration information of a terminal being managed in a management element table is renewed or deleted.

For call processing, when a call processing request message, that is, an INVITE message, is received, an actual processing proxy server is selected by ascertaining the destination address of the INVITE message, and the loads of the processing proxy server are increased in a server table. The increased loads are maintained during a period of call operation. When a call termination message, that is, a BYE message, is received, the loads of the proxy server are decreased. Accordingly, the loads of proxy servers can be ascertained. Other messages used at the time of call processing are examined and bypassed to actual processing proxy servers, so the loads of the load balancing apparatus can be minimized.

In the case where the load balancing apparatus of the present invention is employed, loads that can be processed are determined depending on the number of proxy servers to be used, and loads can be balanced even though hetero-proxy servers are employed. Additionally, a proxy server can be selected on the basis of the current state of loads at the time of processing a REGISTER message, so dynamic load balancing according to current loads is enabled.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a construction of a network to which a SIP-based load balancing apparatus is applied in accordance with a preferred embodiment of the present invention;

FIG. 2 is a diagram showing a construction of the SIP-based load balancing apparatus in accordance with the present invention;

FIG. 3 is a flowchart showing an operation of the SIP-based load balancing apparatus according to the present invention; and

FIG. 4 is a flowchart showing an operation of a timer task unit of the SIP-based load balancing apparatus in accordance with the present invention.

### DESCRIPTION OF THE PREFERRED EMBODIMENTS

Reference now should be made to the drawings, in which the same reference numerals are used throughout the different drawings to designate the same or similar components.

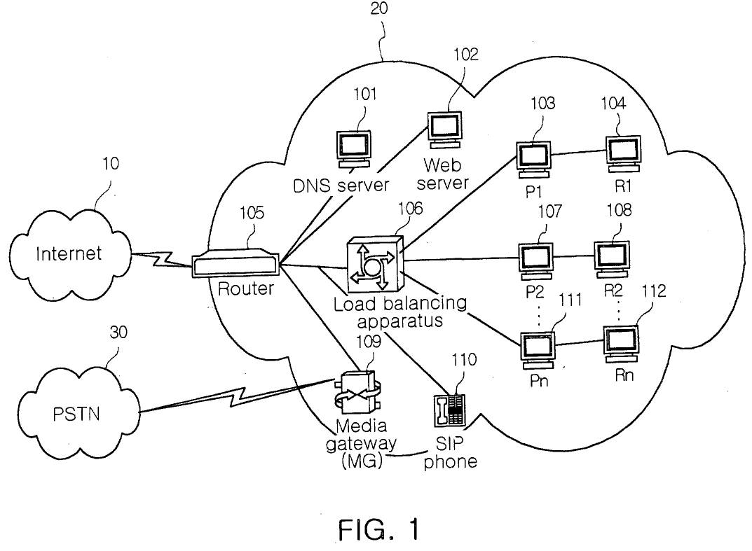

FIG. 1 is a diagram showing a construction of a network to which a SIP-based load balancing apparatus is applied in accordance with a preferred embodiment of the present invention. Referring to FIG. 1, an intra-Local Area Network (LAN) 20 including an SIP-based load balancing apparatus 106 of the present invention is connected to the Internet 10 through a Web server 102 for providing Web services and a router 105 for allowing the intra-LAN 20 to access an external network. Additionally, a SIP-based media gateway 109 may be employed to allow access to a Public Switched Telephone Network (PSTN) 30.

In the environment of the intra-LAN 20, there are provided a DNS server 101 for providing a domain name registration function to provide SIP-based Internet telephony services and the Web server 102 for providing Web services as well as the SIP-based load balancing apparatus 106. Additionally, “n” proxy servers 103, 107, . . . , 111 are connected in parallel to the load balancing apparatus 106 at a position in back of the load balancing apparatus 106. The n proxy servers 103, 107, . . . , 111 are provided with registrars 104, 108, . . . , 112 to be expanded afterward, respectively. The users of an internal Internet telephone 110, the users of the Internet 10 and external proxy servers (not shown) connect a proxy server of a representative domain, that is, the load balancing apparatus 106, and are provided with services.

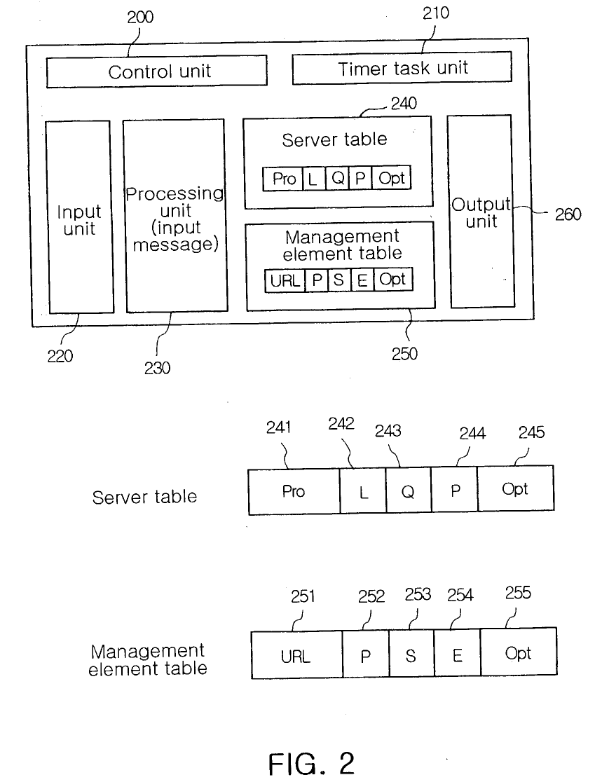

FIG. 2 is a diagram showing a construction of the SIP-based load balancing apparatus in accordance with the present invention. In the environment shown in FIG. 1, the load balancing apparatus 106 of the present invention handles destination address-based load balancing to perform load balancing. The load balancing apparatus 106 of the present invention for handling destination address-based load balancing includes a control unit 200 to control the entire management and operation of the load balancing apparatus 106. The control unit 200 manages entire global variables related to load balancing, a plurality of tables 240 and 250, the entire operation of the load balancing apparatus 106 and troubles. Additionally, the load balancing apparatus 106 further includes an input unit 220, a processing unit 230, a server table 240, a management element table 250 and an output unit 260. The input unit 220 receives messages from the terminals of a domain. The processing unit 230 distributes input messages to proxy servers in consideration of the loads of the proxy servers and handles an increase and a decrease in the loads of the proxy servers at the time of call processing. The server table 240 is used to manage servers necessary at the time of processing. The management element table 250 manages user destination addresses. The output unit 260 transmits processed results to a proxy server to be actually operated. The server table 240 and the management element table 250 are periodically examined by a timer task unit 210, and expired items may be deleted from the tables 240 and 250. The control unit 200 manages the server table 240 to manage servers. The server table 240 includes a Pro field 241 for recording proxy servers to be managed, an L field 242 for recording loads which the proxy servers currently handle, a Q field 243 for appointing a server on a probability base, a P field 244 for recording system characteristics appointed by a manager and an Opt field 245 for processing options. The input unit 220 opens a basically defined port, waits for inputs from users and determines whether an input message has an error. An input message that is determined to have no error as the result of the determination is processed on the basis of the server table 240 and the management element table 250. The processing unit 230 manages the management element table 250 to manage users according to the destination addresses of REGISTER messages. The management element table 250 includes a URL field 251 used to distinguish users from each other, a P field 252 for recording proxy servers to actually process users, a S field 253 for recording times when the REGISTER messages of users are received, an E field 254 for recording expiration values included in the REGISTER messages of users, and an Opt field 255 provided to prepare for future expansion. All the messages processed at the time of processing messages are transmitted through the output unit 260 to proxy servers that actually process the messages.

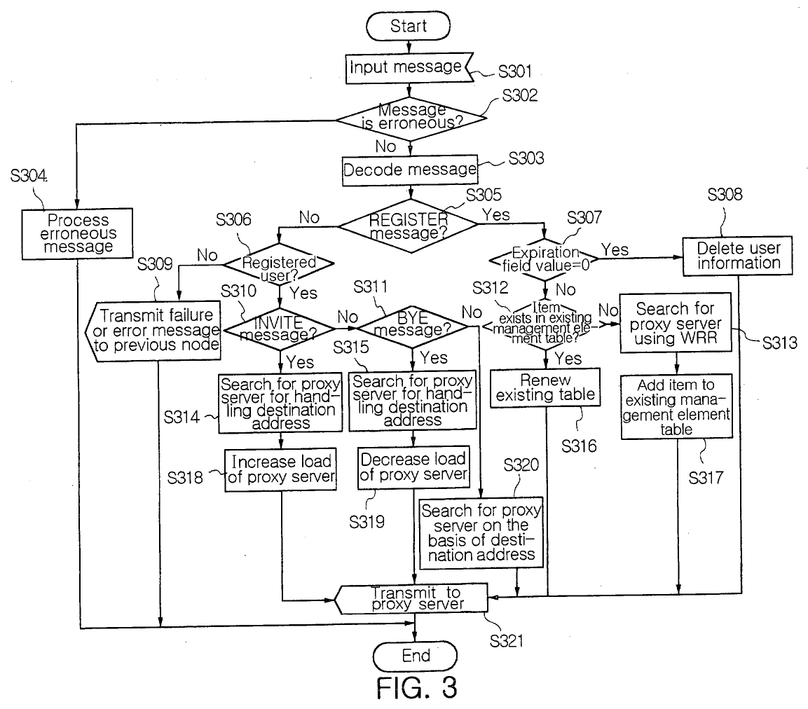

FIG. 3 is a flowchart showing an operation of the SIP-based load balancing apparatus according to the present invention. When a user message is input at step S301, it is determined whether the input message is erroneous at step S302. If the input message is erroneous as the result of the determination at step S301, the input message is made to undergo erroneous message handling at step S304, and then the process ends. In contrast, if the input message is not erroneous as the result of the determination at step S301, the input message is decoded at step S303, and it is determined whether the decoded input message is a REGISTER message at step S305. If the decoded input message is not the REGISTER message as the result of the determination at step S305, it is determined whether the user of the decoded input message is one of registered users existing in the management element table 250 at step S306. If the user is not one of registered users as the result of the determination at step S306, the decoded input message is transmitted to a basic proxy server set by the manager or a failure or error message is transmitted to a previous node at step S309, and then the process ends. In contrast, if the user of the decoded input message is one of registered users existing in the management element table 250 as the result of the determination at step S306, it is determined whether the decoded input message is an INVITE message at step S310. If the decoded input message is the INVITE message as the result of the determination at step S310, the management element table 250 is searched for a proxy server that handles a destination address at step S314. After the load of the proxy server that actually processes the input message is allowed to increase at step S318, the decoded input message is transmitted to the proxy server that actually processes the decoded input message at step S321. If the decoded input message is not the INVITE message as the result of the determination at step S310, it is determined whether the decoded input message is a BYE message at step S311. If the decoded input message is the BYE message as the result of the determination at step S311, a processing proxy server is searched for by ascertaining a destination address in the management element table 250 at step S315. Thereafter, after the load L of the proxy server is made to be decreased in the server table 240 at step S319, the decoded input message is transmitted to a proxy server that actually processes the decoded input message at step S321. In contrast, if the decoded input message is not the BYE message as the result of the determination at step S311, the management element table 250 is searched for a processing proxy server on the basis of a destination address at step S320, and then the decoded input message is transmitted to the proxy server without alteration at step S321.

In the meantime, if the decoded input message is the REGISTER message as the result of the determination at step S305, the head of the REGISTER message is searched for an expiration field, and it is determined whether the value of the expiration field is “0” at step S307. If the value of the expiration field is “0” as the result of the determination at step S307, user information is deleted from the management table 250 at step S308, and then the management table 250 free from the user information is searched for the address of an actual processing proxy server and the decoded input message is transmitted to the searched for proxy server at step S321. In contrast, if the value of the expiration field is not “0” as the result of the determination at step S307, it is determined whether the item of the input message exists in the management element table 240 at step S312. If the item exists in the management element table 240 as the result of the determination at step S321, the management element table 240 is renewed at step S316, and then the input message is transmitted to an actual processing proxy server existing in the management element table 240 at step S321. If the item does not exist in the management element table 240 as the result of the determination at step S321, the server table 240 is searched for an actual processing proxy server using a Weighted Round Robin (WRR) technique at step S312. A processed result is recorded in the management element table 250 at step S317, and thereafter the decoded input message is transmitted to the actual processing proxy server at step S321.

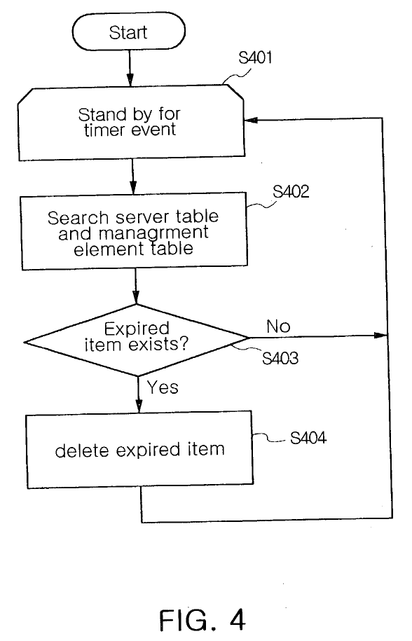

FIG. 4 is a flowchart showing an operation of a timer task unit of the SIP-based load balancing apparatus in accordance with the present invention. The timer task unit 210 of the load balancing apparatus of the present invention serves to search the server table 240 and the management element table 250 at regular intervals while running in a loop, and to delete expired registered information. Referring to FIG. 4, this operation is described in more detail. First, at step S402, the timer task unit 210 stands by for the handling of a timer event. When the timer task unit 210 is operated by the timer event, the timer task unit 210 searches the tables 240 and 250 at step S402. It is determined whether the items of the tables 240 and 250 have expired at step S403. Expired items are deleted from the tables 240 and 250 at step S404. Non-expired items are left as they are, and the process proceeds to step S401 where the timer take unit 210 stands by for the handling of a next timer event.

As described above, the present invention provides an SIP-based load balancing apparatus and method, in which when an SIP and DNS SRV support are employed to use a telephony service on the Internet, messages received at the time of service registration can be distributed among a plurality of proxy servers and other messages can be processed in the same proxy servers depending on their destination addresses, so the state of messages can be managed, which helps to solve the problem of a stateful proxy.

In addition, the SIP load balancing apparatus and method of the present invention is advantageous in that no trouble occurs even though loads are distributed to hetero-proxy servers and loads can be dynamically distributed among the proxy servers depending on the current state of a network.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A Session Initiation Protocol (SIP)-based load balancing apparatus, the SIP-based load balancing apparatus being connected in parallel to a plurality of proxy servers for providing SIP-based voice services, comprising:
a control unit for controlling entire management and operation of the apparatus;
a server table for managing lists of the proxy servers on the basis of destination addresses of users;
a management element table for managing lists of the users on the basis of destination addresses of REGISTER messages;
an input unit for receiving a message transmitted from one of the users;
a processing unit for decoding the message received by the input unit, and balancing loads of the each proxy server in such a way as to distribute a REGISTER message to a corresponding proxy server depending on the loads of the proxy servers if the decoded message is the REGISTER message and increase or decrease a load of a corresponding proxy server if the decoded message is an INVITE message or a BYE message;
an output unit for outputting processed results to corresponding proxy servers; and
a timer task unit for examining the server table and the management element table at preset periods and deleting expired lists.

2. The SIP-based load balancing apparatus according to claim 1, wherein the SIP-based load balancing apparatus is connected in parallel to the plurality of proxy servers at a position in front of the proxy servers.

3. The SIP-based load balancing apparatus according to claim 1, wherein if the decoded message is a REGISTER message, the processing unit ascertains current loads of the each proxy server, selects a proxy server having a smallest load among the proxy servers, transmits the REGISTER message to the proxy server having the smallest load, and stores a registration result in the management element table.

4. The SIP-based load balancing apparatus according to claim 1, wherein the server table comprises:
a first field for recording a proxy server to be managed;
a second field for recording a load of the proxy server to be managed;
a probability value field for designating a server on the basis of probability;
a third field for recording characteristics of the apparatus designated by a manager; and
an option field for handling an option.

5. The SIP-based load balancing apparatus according to claim 1, wherein the management element table comprises:
a uniform resource locator field designed to identify a user;
a fourth field for recording an actual proxy server that will handle the user;
a fifth field for recording time when REGISTER message of the user is received;
a sixth field for recording an expiration value included in the RESISTER message; and
an option field provided to prepare for future expansion.

6. The SIP-based load balancing apparatus according to claim 1, wherein the input unit opens a set port, stands by for a message input from a user and examines the input message for an error.

7. A SIP-based load balancing method, comprising:
a first step of receiving a message transmitted from a user at a position in front of a plurality of proxy servers each being connected in parallel, examining the message for an error, and decoding the received message if the received message is not erroneous;
a second step of selectively performing addition, renewal and deletion of user information according to an expiration field of a header, and transmitting the decoded message to a proxy server, if the decoded message is a REGISTER message;
a third step of searching for a proxy server that will handle a destination address, increasing a load of the proxy server and transmitting the decoded message to the proxy server, if the decoded message is a INVITE message;
a fourth step of ascertaining a corresponding proxy server by examining the destination address, if the decoded message is a BYE message; and
a fifth step of decreasing a load of the proxy server and transmitting the decoded message to the proxy server after the fourth step is performed.

8. The SIP-based load balancing method according to claim 7, wherein the third step includes:
a sixth step of determining whether a value of an expiration field of a header of the REGISTER message is zero;
a seventh step of deleting user information from a previously stored list and transmitting the REGISTER message to an actual processing proxy server, if the value of the expiration field is zero as a result of the determination at the sixth step;
an eight step of determining whether user information exists in the previously stored list, if the value of the expiration field is not zero as a result of the sixth step;
a ninth step of renewing the user information of the previously stored list and transmitting the REGISTER message to a proxy server existing in the previously stored list, if the user information exists in the previously stored list as a result of the determination at the eighth step; and
a tenth step of searching for a proxy server that will handle the REGISTER message and transmitting the REGISTER message to the proxy server, if the user information does not exist in the previously stored list as a result of the determination at the eighth step.

9. The SIP-based load balancing method according to claim 8, wherein the tenth step is performed in such a way that the proxy server is searched for by a weighted round robin technique.

10. A computer-readable storage medium, comprising:
a program capable of implementing,
a first function of receiving a message transmitted from a user at a position in front of a plurality of proxy servers each being connected in parallel, examining the message for an error, and decoding the received message if the received message is not erroneous;
a second function of selectively performing addition, renewal and deletion of user information according to an expiration field of a header, and transmitting the decoded message to a proxy server, if the decoded message is a REGISTER message;
a third function of searching for a proxy server that will handle a destination address, increasing a load of the proxy server and transmitting the decoded message to the proxy server, if the decoded message is a INVITE message;
a fourth function of ascertaining a corresponding proxy server by examining the destination address, if the decoded message is a BYE message; and
a fifth function of decreasing a load of the proxy server and transmitting the decoded message to the proxy server after the fourth function is performed.
